(19) United States
(12) Patent Application Publication
(10) Pub. No.: US 2026/0284921 A1
(43) Pub. Date: Sep. 24, 2026

(54) SIZE-REDUCTION MACHINES AND COMPONENTS THEREOF

(71) Applicant: Urschel Laboratories, Inc., Chesterton, IN (US)

(72) Inventors: Dustin J. Gereg, Valparaiso, IN (US); William Monroe, Valparaiso, IN (US); Scott Alan Klockow, Valparaiso, IN (US)

(21) Appl. No.: 19/691,136

(22) Filed: May 28, 2026

Related U.S. Application Data
(62) Division of application No. 18/810,939, filed on Aug. 21, 2024.
(60) Provisional application No. 63/520,802, filed on Aug. 21, 2023.

(51) Int. Cl. B26D 7/06; B26D 1/03; B26D 7/26; B26D 7/00

(52) U.S. Cl. CPC B26D 7/0691; B26D 1/03; B26D 7/2614; B26D 2007/0018; B26D 2210/02

(57) ABSTRACT

Size-reduction machines and components thereof for producing reduced-size products. Such a size-reduction machine has a case and an impeller that rotates within the case, is surrounded by the case, and has a common axis with the case. A particular feature but optional feature of such a machine is a moveable gate that promotes the ability to produce slices having a very uniform thickness throughout their lengths, from their leading edges to their trailing edges.

### CROSS-REFERENCE TO RELATED APPLICATIONS

This is a division patent application of co-pending United States patent application Serial No. 18/810,939 filed Aug. 21, 2024, which claims priority to U.S. Provisional Application No. 63/520,802 filed Aug. 21, 2023. The contents of these prior patent documents are incorporated herein by reference.

### BACKGROUND OF THE INVENTION

The present invention generally relates to methods and machines for cutting solid and semisolid materials, including food products. The invention particularly relates to size-reduction machines and methods for producing sliced, strip, and diced products, and components of such machines.

The DiversaCut Sprint® dicer is a nonlimiting example of a size-reduction machine manufactured by Urschel Laboratories, Inc., and is particularly well suited for slicing, strip-cutting, and dicing various materials, notable but nonlimiting examples of which include vegetables, fruits, and meats. The DiversaCut Sprint® dicer is well known as capable of high capacity output and precision cuts, as well as for its versatility to be capable of making a variety of cut sizes and types to produce a wide variety of products.

A nonlimiting representation of a cutting section of a DiversaCut Sprint® size-reduction machine 10 is shown in FIG. 1. Products 16 are delivered to the machine 10, for example, through a feed hopper (not shown), and enter a rotating impeller 12 through an axial opening of the impeller 12. The impeller 12 is equipped with paddles 14 and, as the impeller 12 rotates, centrifugal forces hold the products 16 against an inner wall 18 of a stationary case 20 equipped with a slicing knife 22. The slicing knife 22 is typically oriented approximately parallel to a rotational axis 24 that is represented in FIG. 1 as horizontal and common to the impeller 12 and case 20 (and as such may sometimes be referred to herein simply as the axis 24 of the impeller 12, the case 20, or the impeller 12 and case 20). The paddles 14 of the impeller 12 carry the products 16 in a circumferential direction of the case 20 (represented as clockwise in FIG. 1) to the slicing knife 22, whose cutting edge 22A cuts (slices) the products 6 to produce slices 26 of the products 26. The slicing knife 22 is disposed in or adjacent an opening in the case 14 that defines an outlet for the slices 26 exiting the machine 10.

In the nonlimiting embodiment shown in FIG. 1, after exiting the case 20 the slices 26 enter a dicing unit 28 of the machine 10. As used herein, the dicing unit 28 comprises a part of the machine 10 downstream of the slicing knife 22 and generally includes a circular cutter 30 that cuts the slices 26 into strips. The nonlimiting embodiment of FIG. 1 further shows the strips as then being diced by crosscut knives 34 of a cross-cutter 32 to produce a diced product 36. Both the circular cutter 30 and the cross-cutter 32 rotate about their respective axes of rotation. The cross-cutter 32 can be removed so that the strips are the final product of the machine 10, and the circular cutter 30 can also be removed so that the slices 26 are the final products of the machine 10.

Though slice thickness is not critical for every application, slices having a controlled and uniform thickness are desirable and possibly even critical for others. The thicknesses of slices 26 produced with the machine 10 of FIG. 1 are determined by a moveable gate 38 positioned ahead of, or "leading," the slicing knife 22. The gate 38 is represented as pivotably coupled to the case 20 at a leading end 40 of the gate 38, and pivoted by an adjustment device 44 located adjacent a trailing end 42 of the gate 38. As used herein, "leading" (and related forms thereof) refers to a position on the case 20 (or a component thereof) that is ahead of or precedes another in the direction of rotation of the impeller 12 within the case 20, whereas "trailing" (and related forms thereof) refers to a position on the case 20 (or a component thereof) that follows or succeeds another relative to the rotational direction of the impeller 12. As such, the case 20 can be characterized as having a leading direction (in FIG. 1, along the counterclockwise circumferential direction of the case 20), a trailing direction opposite the leading direction (in FIG. 1, along the clockwise circumferential direction of the case 20), and an axial direction that is parallel to the axis 24 of the impeller 12 and generally perpendicular to the leading and trailing directions. Because the impeller 12 and case 20 are substantially coaxial, the impeller 12 and case 20 can also be characterized as having a radial direction that passes through the axis 24 of the impeller 12 and is perpendicular to the leading, trailing, and axial directions. On this basis, the gate 38 can be described as pivoted by the adjustment device 44 in generally radial directions (both radially inward and radially outward) of the case 20.

While size-reduction machines such as the DiversaCut Sprint® have performed extremely well for their intended purpose, there is an ongoing desire for improvements in machines of this type.

### BRIEF DESCRIPTION OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, size-reduction machines and methods capable of producing a variety of sliced, strip, and/or diced products, and to components of such machines.

According to certain preferred aspects of the invention, such a size-reduction machine has a case and an impeller that rotates within the case, is surrounded by the case, and has a common axis with the case.

According to a nonlimiting aspect of the invention, the case includes a slicing knife mounted on a perimeter of the case, a moveable gate leading the slicing knife such that products slide across an inner wall of the gate before encountering the slicing knife, and an adjustment device that translates the gate and restricts the gate to linear translation along a linear path. A technical effect of the moveable gate is the ability to produce slices having a very uniform thickness throughout their lengths, from their leading edges to their trailing edges.

According to another nonlimiting aspect of the invention, the size-reduction machine includes a slicing knife mounted on a perimeter of the case, a moveable gate leading the slicing knife such that products slide across an inner wall of the gate before encountering the slicing knife, and a cutting device leading the slicing knife. The cutting device includes a mounting fixture and stationary strip knives that are spaced apart and parallel to each other by the mounting fixture.

According to yet another nonlimiting aspect of the invention, the size-reduction machine includes a slicing knife mounted on a perimeter of the case, and a feed assembly with a chute having a chute opening adapted for receiving a product from the slicing knife. The feed assembly further has a bin pivotally attached to the chute so that rotating the bin away from the chute opening exposes a cavity within the bin that accommodates a limited quantity of the product, an interior wall of the bin prevents access to the chute, and the product within the cavity is deposited in the chute by rotating the bin toward the chute opening.

According to still another nonlimiting aspect of the invention, the size-reduction machine includes a slicing knife mounted on a perimeter of the case, a product discharge for discharging processed product from the machine after being reduced in size by the slicing knife wherein the product discharge includes deflectors that are located at an exit of the case and define a chute therebetween, a bin for receiving the processed product, and a tray adapted to support the bin and adapted to be pivoted upward to serve as another deflector for conducting the product from the chute.

Other nonlimiting aspects of the invention include a slicing knife mounted on a perimeter of the case, and a cross cutter having a spindle and a knife assembly mounted to the spindle. The knife assembly includes an insert having a plurality of peripheral slots into which cross cut knives are installed along a circumference of the insert. The spindle includes a hub and end caps attached to the hub. The insert is formed of a plastic material and serves as a spacer for the knives, the knives are installed in slots formed in radial projections that extend longitudinally along a length of the insert, and the spindle is constructed of a material that is stronger than the insert.

Still other nonlimiting aspects of the invention include a slicing knife mounted on a perimeter of the case and a slice guide adjustment mechanism downstream of the slicing knife. The slice guide adjustment mechanism defines a guide path that can be precisely adjusted to be equal to thicknesses of slices being produced by the slicing knife.

Other aspects and advantages of this invention will be better appreciated from the following detailed description.

### BRIEF DESCRIPTION OF THE DRAWINGS

FIG. 1 schematically represents a nonlimiting example of a size-reduction machine comprising an impeller rotating within a case about a substantially horizontal axis.

FIG. 2 diagrammatically represents interrelationships of factors that determine uniformity of a leading-trailing thickness of a slice produced by a size-reduction machine of a type represented in FIG. 1.

FIG. 3 identifies a box bounding an "ideal gate center location" for centers of curvature of a gate of the case of FIG. 1 that are theoretically capable of producing slices having uniform leading-trailing thicknesses for a given range of case diameters, slice thicknesses, and product sizes.

FIG. 4 represents a case and gate for a size-reduction machine of the type represented in FIG. 1 in accordance with a nonlimiting embodiment of the invention.

FIGS. 5 through 10 represent various different aspects of the case and gate of FIG. 4.

FIGS. 11 through 15 represent a cutting device capable of use with a size-reduction machine of the type represented in FIG. 1.

FIGS. 16 through 22 represent various aspects of an assembly fixture suitable for use with a size-reduction machine of the type represented in FIG. 1 and/or with the cutting device represented in FIGS. 11 through 15.

FIGS. 23 and 24 represent a feed assembly capable of delivering products to a size-reduction machine of the type represented in FIG. 1.

FIGS. 25 through 28 represent a product discharge adapted to discharge processed products from a size-reduction machine of the type represented in FIG. 1.

FIGS. 29 through 32 represent a cross-cutter capable of use with a size-reduction machine of the type represented in FIG. 1.

FIGS. 33 through 35 represent a slice guide adjustment mechanism capable of use with a size-reduction machine of the type represented in FIG. 1.

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of what is depicted in the drawings, including the embodiment(s). The following detailed description also identifies certain but not all alternatives of the embodiment(s) depicted in the drawings. As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter that is regarded to be aspects of the invention, including certain but not necessarily all of the aspects and alternatives described in the detailed description.

Some of the drawings represent certain dimensions or other aspects of various components that are believed to be exemplary, but are otherwise not necessarily limitations to the scope of the invention.

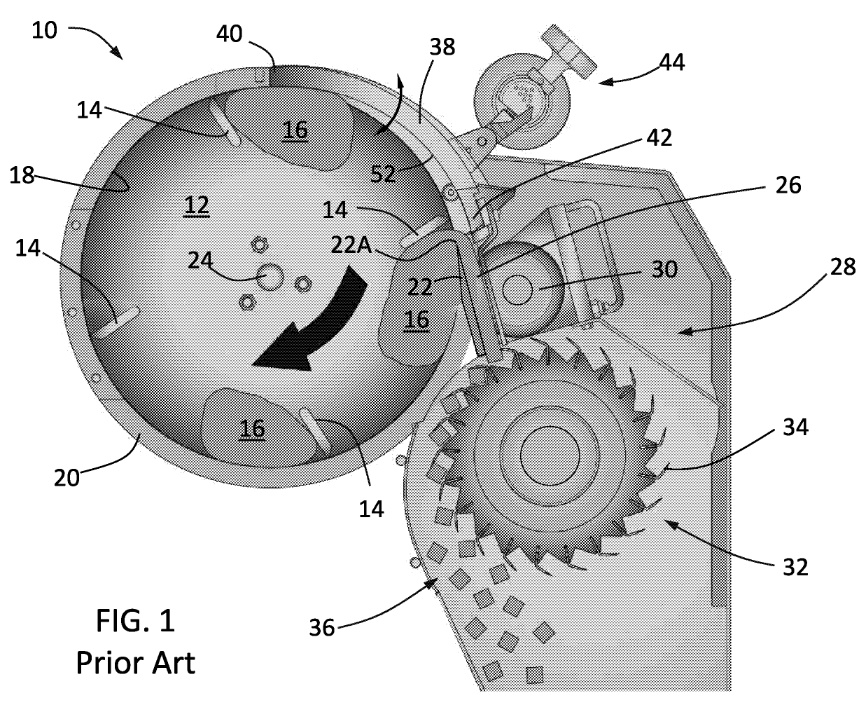

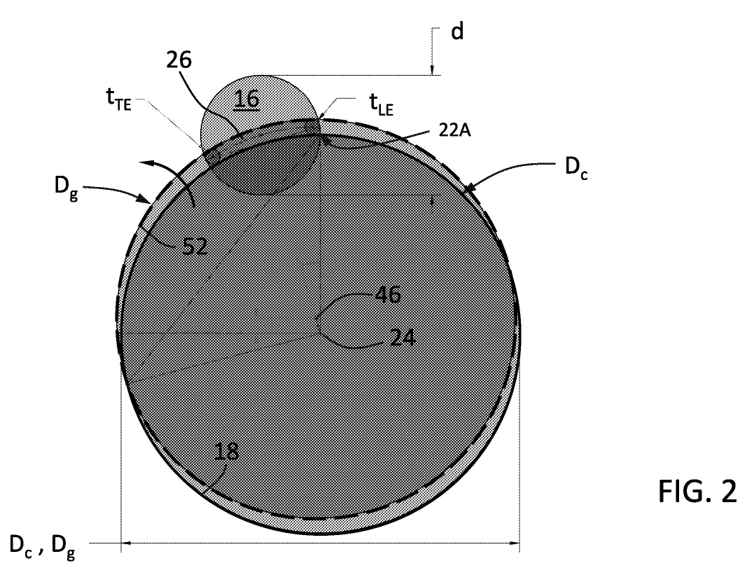

FIGS. 2 through 35 schematically represent components of a size-reduction machine, as a nonlimiting example, the DiversaCut Sprint® machine represented in FIG. 1. As such, the following discussion will make reference to the size-reduction machine 10 of FIG. 1, and consistent reference numbers are used in FIGS. 2 through 35 to identify components that are the same or functionally equivalent to components identified in FIG. 1. Other aspects not discussed in any detail may be, in terms of structure, function, materials, etc., essentially as was described for FIG. 1. Although the invention will be described hereinafter in reference to the machine 10 shown in FIG. 1, it will be appreciated that the teachings of the invention are more generally applicable to other types of size-reduction machines, including but not limited to other size-reduction machines manufactured by Urschel Laboratories, Inc., and others.

Referring to FIG. 1, it can be seen that, whereas the uniformity of the thicknesses of slices 26 in the axial direction is controlled by properly orienting the slicing knife 22 relative to the inner wall 18 of the case 20, the "leading-trailing" thickness of the slices 26 in the circumferential direction of the case 20, i.e., from the leading edge of the slice 26 (the first part of the slice 26 formed when the product 16 first encounters the cutting edge 22A of the knife 22) to the trailing edge of the slice 26 (the last part of the slice 26 formed as the product 16 disengages the knife 22). (It should be noted here that, in reference to the slice thickness, the terms "leading" and “trailing” differ from the same terms when used to describe the machine 10 and its components.) The leading-trailing thickness of the slices 26 is affected by the degree to which the gate 38 has been pivoted because an inner wall (sliding surface) 52 of the gate 38 contacted by the product 16 arcuately slopes in a radially outward direction relative to the common axis 24 of the impeller 12 and case 20. Experimentally it has been shown that this influence on the uniformity of the leading-trailing thickness of each slice 26 is amplified as the diameter of the case 20 decreases, the target thickness of the slice 26 decreases, and the nominal size of the product 16 increases. As a nonlimiting example, for a targeted slice thickness of 0.04 inch (about 0.1 cm) and a case diameter of about 10 inches (about 25 cm), the thickness uniformity can vary by 0.02 inch (about 0.05 cm) or more.

The interrelationships of these factors are diagrammatically represented in FIG. 2, which shows two overlapping circles representing the nominal diameter (D_{c}) of the case 20 (solid line) and the effective diameter (D_{g}) of the gate 28 (dashed line) as equal but offset from each other as a result of the center of curvature 46 of the gate 38 being offset from the axis 24 of the case 20 due to the gate 38 being pivoted radially outward and away from the axis 24. As represented in FIG. 2, a slice 26 is in the process of being produced from a product 16 having a nominal size (diameter, d) to have a slightly nonuniform leading-trailing thickness due to differences between the slice thickness at the leading edge (t_{LE}) of the slice 26 (represented as located at a cutting edge 22A of the knife) and the trailing edge (t_{TE}) of the slice 26 (represented as located at a location on the gate 38 trailing the cutting edge 22A of the knife).

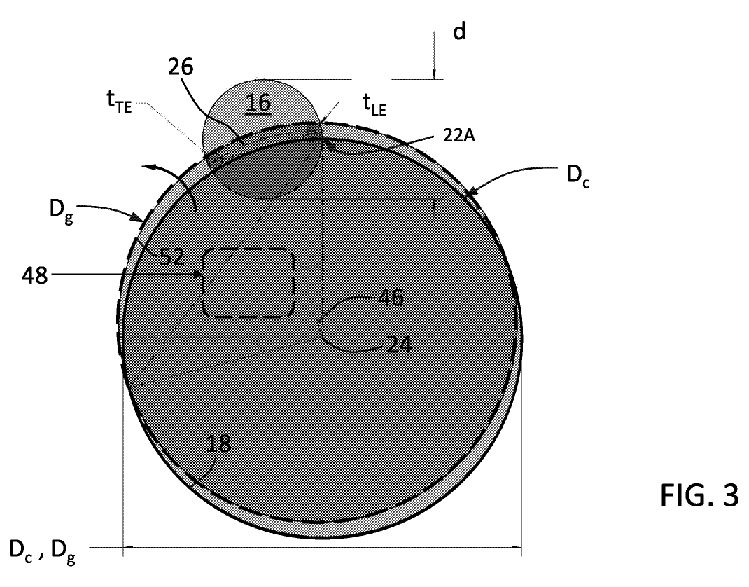

FIG. 3 is diagrammatically similar to FIG. 2, but further identifies a box 48 bounding an ideal gate center location for centers of curvature 46 of the gate 38 that theoretically would be capable of producing slices 26 having uniform leading-trailing thicknesses for a given range of case diameters, slice thicknesses, and product sizes. The bounding box 48 was calculated using the diameter of the case 20, the target thickness of the slice 26, and the nominal size of the product 16 as variables.

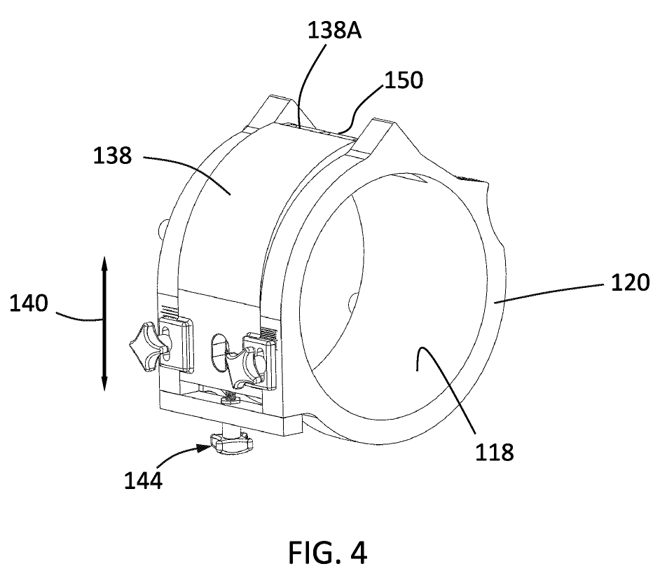

To provide for control of the center of curvature of a gate within a bounding box as depicted in FIG. 3, FIGS. 4 through 10 represent a case 120 and gate 138 for a size-reduction machine (such as the machine 10 of FIG. 1) in which the case 120 and gate 138 have been modified so that the gate 138 does not pivot relative to the case 120, but instead is linearly translated along a linear path 140 with an adjustment device 144. FIG. 4 represents the linear path 140 as preferably parallel to a tangent of the nominal diameter of the case 120. As with the gate 38 of FIG. 1, the gate 138 represented in FIGS. 4 through 10 is a moveable gate 138 positioned ahead of (leading) a slicing knife 122 mounted on the perimeter of the case 120, such that products slide across an inner wall (sliding surface) 152 of the gate 138 before encountering the slicing knife 122. The adjustment device 144 is represented as a threaded adjuster that restricts the gate 138 to linear movement, though it is foreseeable that other types of devices could be employed for this purpose, such as a an electric, hydraulic, or pneumatic linear actuator. The case 120 is configured for use in combination with an impeller (not shown, but such as the impeller 12 of FIG. 1) that rotates within the case 120, is surrounded by the case 120, and has a common axis with the case 120 that is represented as being a horizontal axis, as described in reference to FIG. 1. Though the case 120 and its gate 138 operate in combination with such an impeller, the following discussion will be focused on physical interrelationships of the case 120, its gate 138, and other components of the case 120, and the presence of an impeller is implied but will not be discussed in any detail.

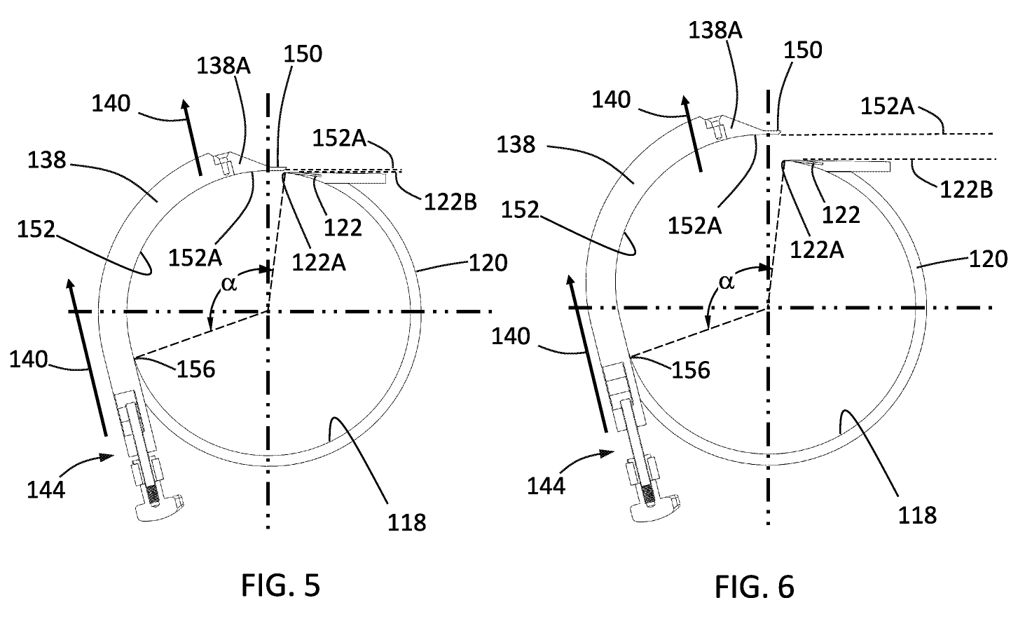

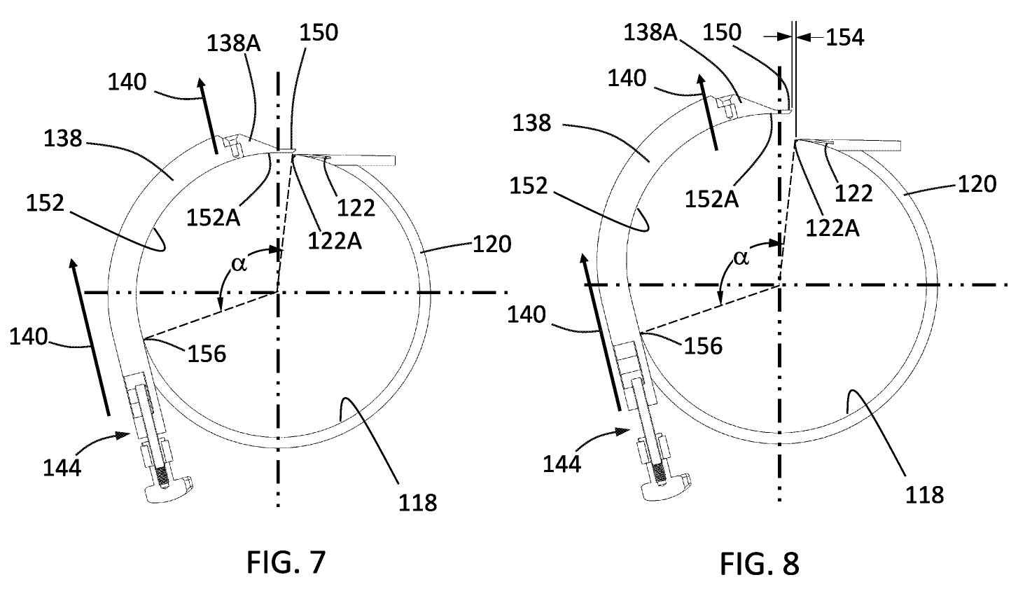

FIGS. 5 through 10 represent two adjustment extremes (though not necessarily physical limits) for the gate 138 relative to the case 120 of FIG. 4. FIGS. 5 and 6 schematically represent that the linear translation of the gate 138 along the linear path 140 is controlled so that a trailing edge 150 of the gate 138 moves (translates) linearly relative to (toward and away from) the cutting edge 122A of the slicing knife 122, resulting in the ability to selectively increase and decrease the radial distance between the trailing edge 150 of the gate 138 and the cutting edge 122A of the slicing knife 122. Additionally, FIGS. 5 and 6 represent that a surface 152A of the inner wall 152 of the gate 138 contiguous with its trailing edge 150 is parallel (or nearly parallel) to the radially outer surface 122B of the slicing knife 122 throughout the translation of the gate 138. FIGS. 7 and 8 further represent that the case 120 and gate 138 form a throat 154, defined as the circumferential distance between the trailing edge 150 of the gate 138 and the cutting edge 122A of the slicing knife 122. The throat 154 is zero or nearly zero in FIG. 7 when the trailing edge 150 of the gate 138 is nearer the cutting edge 122A of the slicing knife 122, and the throat 154 is only slightly increased as the gate 138 is translated radially outward away from the cutting edge 122A.

FIGS. 5 through 8 further represent the inner wall 152 of the gate 138 exposed within the case 120 as encompassing an arc within the case 120 having an angle α of greater than 90 degrees, preferably up to less than 120 degrees, as measured from the junction 156 of the gate 138 and case 120 to the cutting edge 122A of the slicing knife 122. This angular range for α is believed to promote the uniformity of leading-trailing slice thicknesses for products 16 with nominal diameters (d in FIGS. 2 and 3) of up to one-half the diameter (D_{c} in FIGS. 2 and 3) of the case 120. Depending on the nominal diameter of the product 16 and the diameter of the case 120, the angular range for α may more preferably be about 95 to 100 degrees for products whose nominal diameters are about 10% to 20% of the diameter of the case 120, about 105 to 110 degrees for products whose nominal diameters are about 30% to 40% of the diameter of the case 120, and about 110 to less than 120 degrees for products whose nominal diameters are about 50% of the diameter of the case 120.

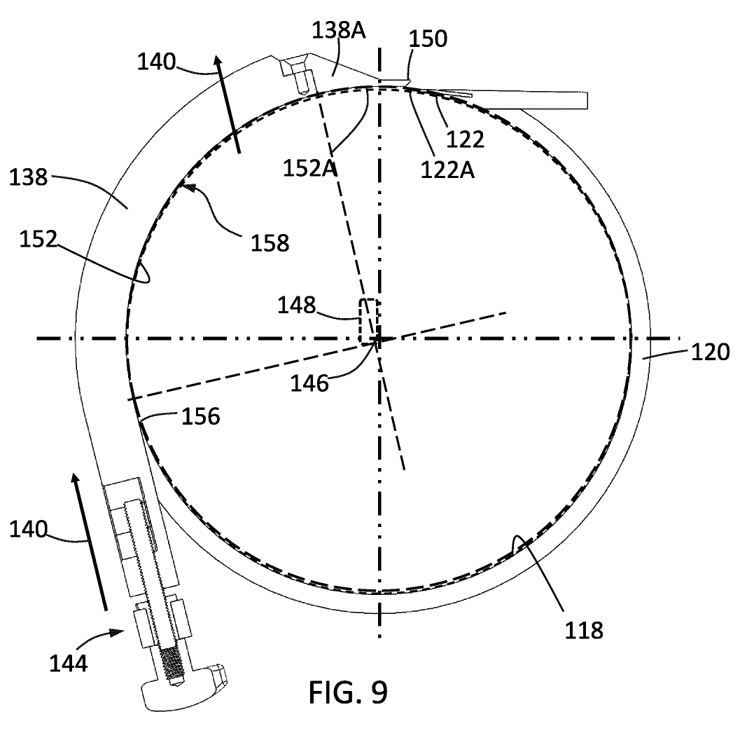

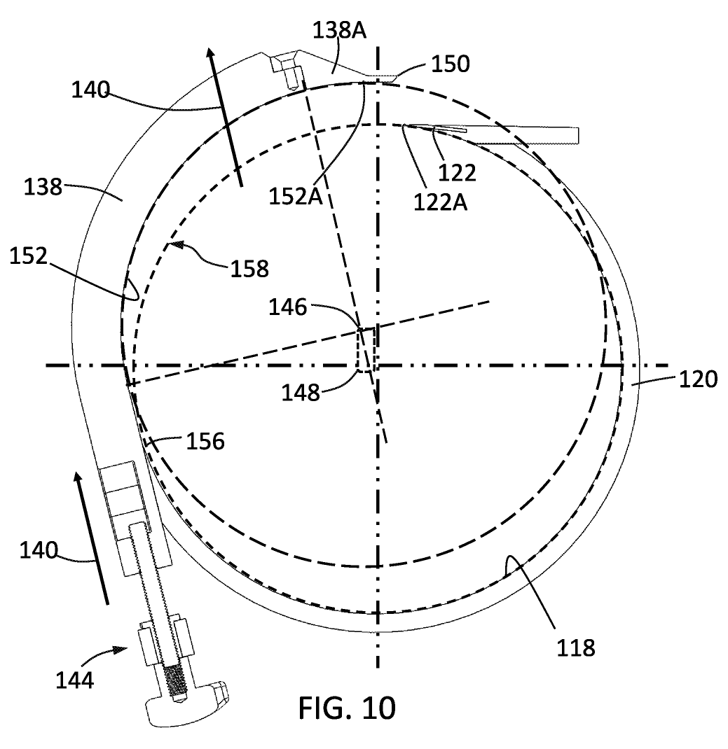

In addition to achieving parallel surfaces for the gate 138 and knife 122 (FIGS. 5 and 6) and a minimal change in the throat 154 at the gate opening (FIGS. 7 and 8) as slice thickness changes, the linear adjustment of the gate 138 represented in FIGS. 4 through 8 preferably provides for a smooth transition from the inner wall 118 of the case 120 to the inner wall 152 of the gate 138. As represented in FIGS. 9 and 10, even at the adjustment extremes represented in FIGS. 4 through 10, the inner wall 152 of the gate 138 in the vicinity of its junction 156 with the inner wall 118 of the case 120 closely follows the circular shape of the inner diameter 158 of the case 120.

As described above, the gate 138 represented in FIGS. 4 through 10 can be characterized by the angle α of the arc of the inner wall 152 of the gate 138 exposed within the case 120 between the junction 156 and cutting edge 122A of the slicing knife 122. As depicted in FIGS. 9 and 10, the gate 138 can be also characterized by a bounding box 148 for the center of curvature 146 of the gate 138 relative to the center of the case 120. Whereas the angle α is driven by product size and is a relatively fixed value for the case 120, the location of the center of curvature 146 of the gate 138 relative to the center of the case 120 varies depending on the distance that the gate 138 has been linearly translated with the adjustment device 144. Compared to the bounding box 48 of FIG. 3, the location of the center of curvature 146 of the gate 138 depicted in FIGS. 9 and 10 lies within a relatively small bounding box 148 and the angle of the direction of the center of curvature 146 from the center of the case 120 does not change throughout the translation range of the gate 138 shown in FIGS. 9 and 10, thus enabling the case 120 to produce slices having consistent thicknesses between their leading and trailing ends over the range of slice thicknesses obtained with the adjustment device 144.

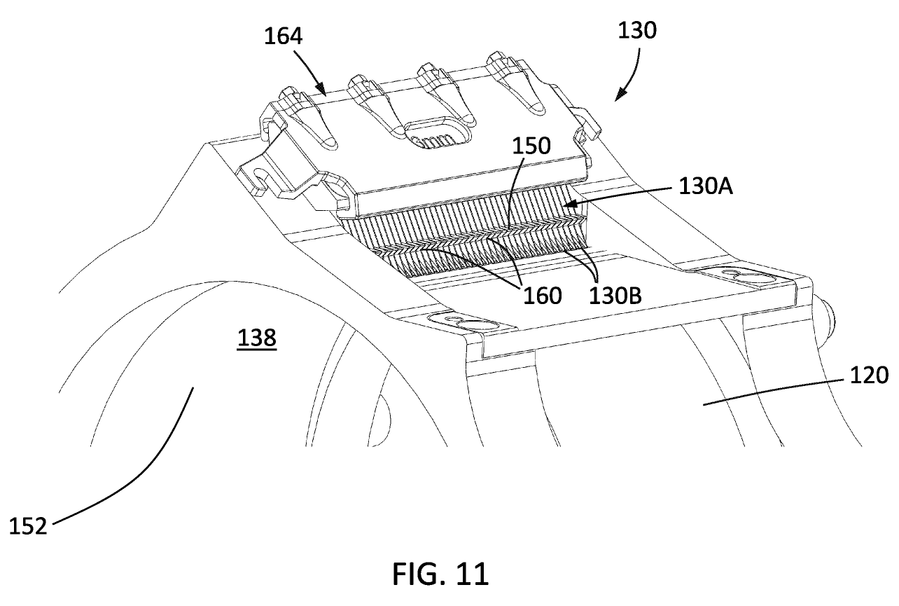

FIGS. 11 through 35 represent additional possible features capable of being incorporated into a size-reduction machine, as a nonlimiting example, the DiversaCut Sprint® machine represented in FIG. 1. Such additional features can be incorporated independent of or in combination with a size-reduction machine configured as described for FIGS. 4 through 10.

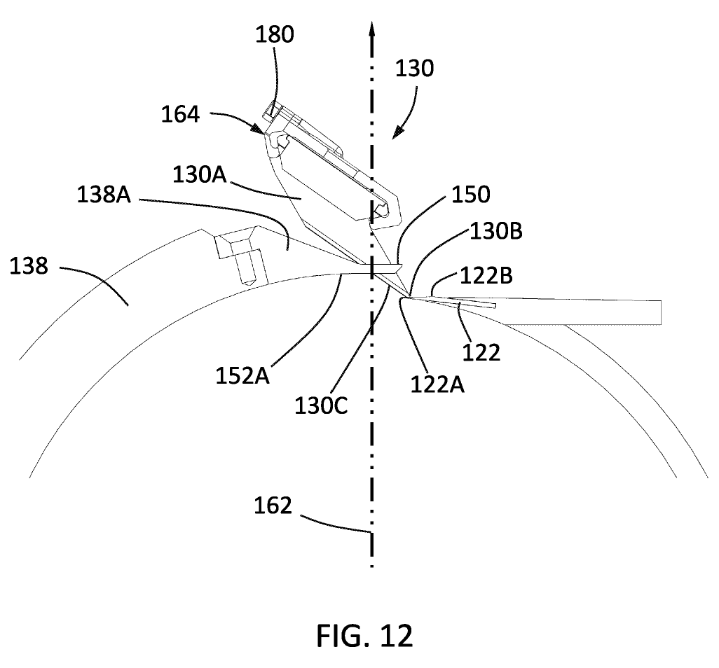

FIGS. 11 through 22 relate to an alternative to the circular cutter 30 of FIG. 1 that is used to cut the slices 26 into strips. Instead of a cutting device with rotating blades, FIGS. 11 through 15 depict a cutting device 130 comprising stationary (fixed) strip knives 130A that are spaced apart and parallel to each other. The strip knives 130A are represented in FIG. 12 as passing through slots 160 (FIG. 11) located at the trailing edge 150 of the gate 138 to immobilize the strip knives 130A in the axial direction of the case 120. The strip knives 130A are shown in FIG. 12 as extending to the slicing knife 122 such that tips 130B of the strip knives 130A contact the upper surface 122B of the slicing knife 122 at locations in the trailing direction behind the cutting edge 122A of the slicing knife 122. The strip knives 130A are also held in a mounting fixture 164 such that the tips 130B thereof contact the upper surface 122B of the slicing knife 122 with a slight surface pressure. As a result, the strip knives 10A are supported at three locations - at the mounting fixture 164, within their respective slots 160 of the gate 138, and at their points of contact with the slicing knife 122 - which in combination promote the rigidity of the strip knives 130B during use.

A preferred but nonlimiting aspect of the invention is that the trailing edge 150 of the gate 138 and the surface 152A of the gate 138 contiguous with the trailing edge 150 can be defined by a gate insert 138A that is removably mounted to the gate 138, such as with screws, as shown in FIGS. 4 through 10 and 12. In this manner, the gate 138 can be quickly modified with a different insert 138A having a different spacing between slots 160 for use in combination with the cutting device 130 whose knives 130A are spaced apart to produce strips of a desired width.

The cutting edges 130C of the strip knives 130A are inclined at an angle so as to not be parallel to a radial 162 of the case 120 that passes through the cutting edges 130C and so that the strip knives 130A intersect their respective slots 160 at locations in the leading direction ahead of the tips 130B of the strip knives 130A and therefore also in the leading direction ahead of the cutting edge 122A of the slicing knife 122. As a result, a product undergoing cutting within the case 120 encounters the cutting edges 130C of the strip knives 130A before the product encounters the cutting edge 122A of the slicing knife 122. FIG. 12 represents the cutting edges 130C of the strip knives 130A as disposed at an angle of about 45 degrees to the radial 162, though lesser and greater angles are foreseeable. The inclination of the cutting edges 130C of the strip knives 130A causes products to gradually undergo strip cutting, as opposed to an abrupt cut that would occur if the cutting edges 130C of the strip knives 130A were parallel to the radial 162 of the case 120. In the particular configuration shown in FIG. 12, the strip cut performed on a product undergoing cutting within the case 120 may be greater than 50% complete before the resulting strips encounter the cutting edge 122A of the slicing knife 122 and yet, due to the locations of the tips 130B of the strip knives 130A being behind the cutting edge 122A of the slicing knife 122, the strip cut is not 100% complete until after the strips are sliced with the cutting edge 122A of the slicing knife 122 to ensure complete cuts and no connected strips.

FIGS. 13 through 15 show isolated views of the cutting device 130, including its mounting fixture 164 and strip knives 130A. As noted above, the mounting fixture 164 serves as one of three locations where the strip knives 130A are supported, the others being the slots 160 in the gate insert 138A and the points of contact with the slicing knife 122. The mounting fixture 164 comprises a carrier 166, a clamp 168 that secures the strip knives 130A to the carrier 166, and two knife spacers 170 and 172 that establish the spacing between the knives 130A. For example, the spacer 170 may be equipped with projections that extend downward between adjacent knives 130A and spaced apart to sufficiently mate with the knives 130A to maintain their parallel and spaced arrangement. In this manner, replacing the spacer 170 with a different spacer 170 that establishes a different spacing between knives 130A enables strips having a different width to be produced with the cutting device 130. Furthermore, the spacer 170 and knives 130A define a subassembly that allows the knives 130A to be handled while remaining installed between the spacer projections.

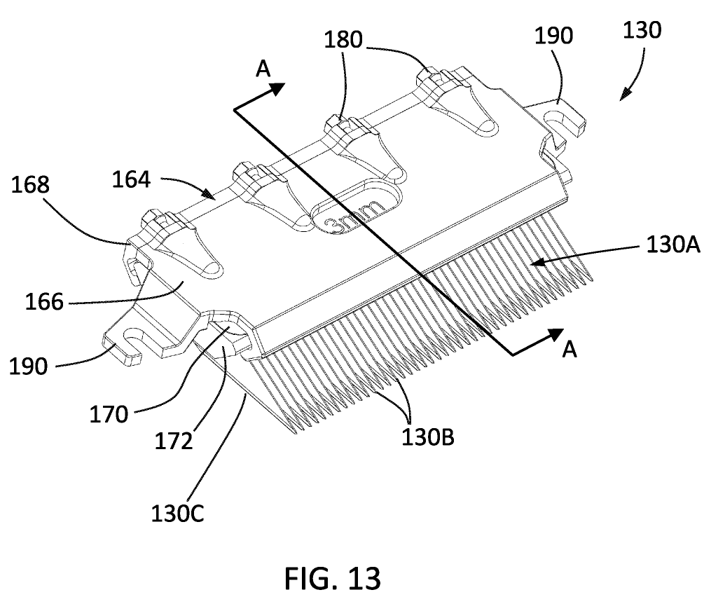

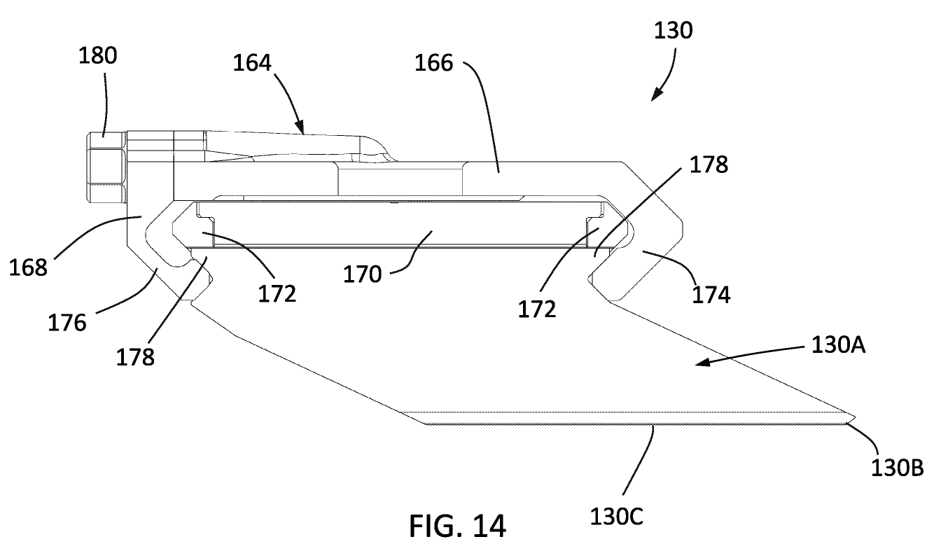

As evident in FIG. 14, the strip knives 130A are clamped in a dovetail-type manner to secure the knives 130A within the cutting device 130. The carrier 166 has a front end that defines a flange 174 having a U or V-shaped cross-section. The clamp 168 is disposed at a back end of the carrier 166 and defines a flange 176 that is a mirror image of the carrier flange 174 but otherwise may have the same or similar U or V-shaped cross-section. The interior angles formed by the flanges 174 and 176 provide recesses in which a dovetail feature 178 on each knife 130A is received and retained by securing the clamp 168 to the carrier 166, for example, with fasteners 180 as shown. By removing the clamp 168, the aforementioned subassembly formed by the spacer 170 and knives 130A can be removed from the mounting fixture 164 as a unit, permitting the subassembly to be replaced with another subassembly comprising knives 130A installed in second spacer 170. The replacement subassembly may have knives 130A and/or a spacer 170 that is/are different from or identical to those of the replaced subassembly, for example, to produce strips having an identical or different width.

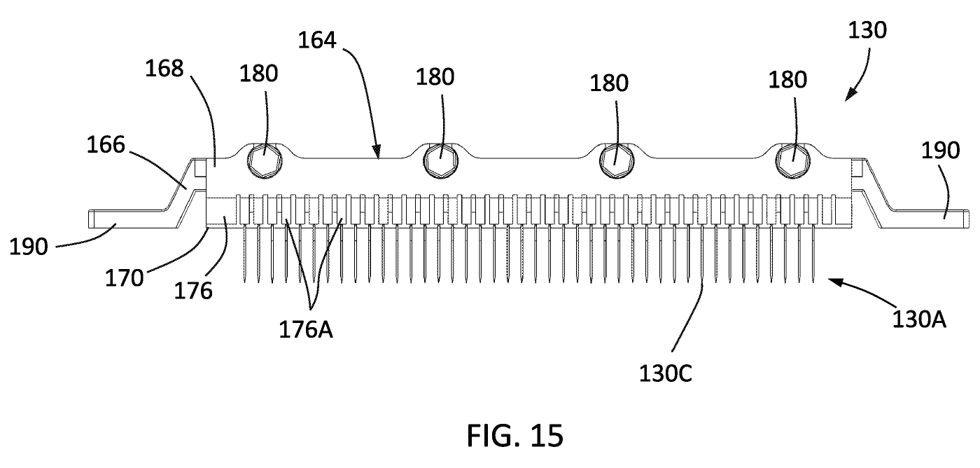

The clamping action between the flange 176 and its adjacent dovetail feature 178 on each knife 130A causes the flange 176 to deflect. To allow for this deflection and the generation of a desired clamping force at each knife 130A, FIG. 15 represents the flange 176 as comprising individual fingers 176A that can independently deflect for each of their respective knives 130A.

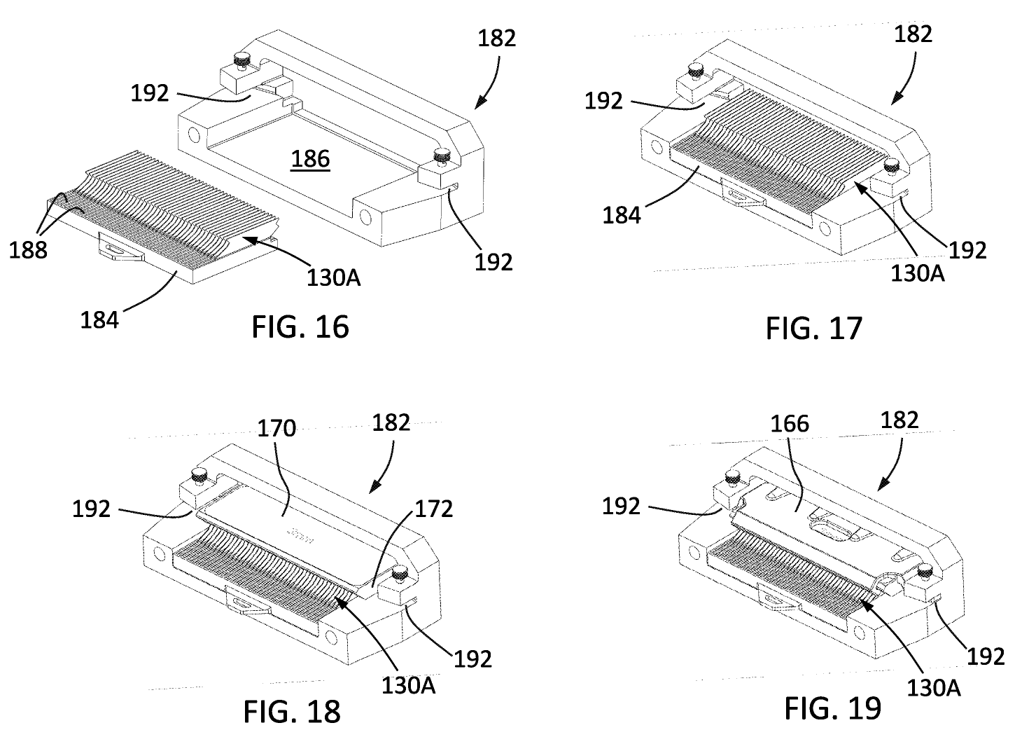

FIGS. 16 through 22 schematically represent an assembly fixture 182 with which the strip knives 130A can be assembled with the spacers 170 and 172, carrier 166, and clamp 168 to yield the mounting fixture 164, as well as cleaned and installed in a size-reduction machine, as a nonlimiting example, the DiversaCut Sprint® machine represented in FIG. 1. Additionally, the assembly fixture 182 is intended to enable more rapid removal and installation of the knives 130A into the cutting device 130 while the cutting edges 130C of the knives 130A are concealed.

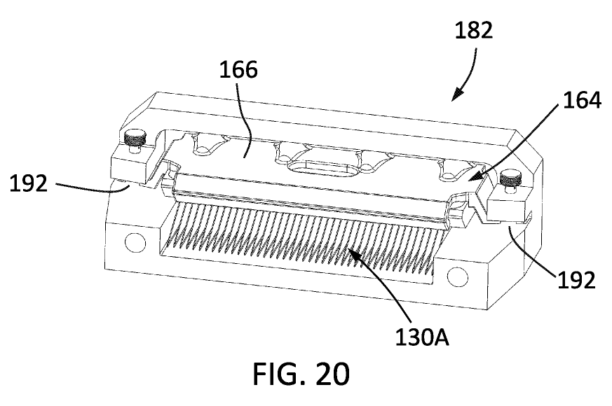

In FIG. 16, the strip knives 130A are shown assembled in a tray 184 and aligned for placement on a bed 186 of the assembly fixture 182. The tray 184 comprises slots 188 that are spaced apart corresponding to the intended spacing of the knives 130A in the mounting fixture 164. FIG. 17 shows the tray 184 and its knives 130A placed on the bed 186 of the fixture 182, FIG. 18 shows the spacers 170 and 172 assembled onto the knives 130A, and FIG. 19 shows the carrier 166 assembled onto the knives 130A and spacers 170 and 172. In FIG. 19, the carrier 166 is installed on the fixture 182 so that flanges 190 of the carrier 166 (FIGS. 13 and 15) are secured within slots 192 of the fixture 182. Subsequent assembly of the clamp 168 (not shown) to the carrier 166 yields the mounting fixture 164. In FIG. 20, the tray 184 has been removed, exposing the cutting edges 130C of the knives 130A but in an orientation facing the bed 186 of the assembly fixture 182 to minimize the risk of injury to the assembler. The cutting edges 130C are sufficiently exposed to enable the knives 130A to be cleaned if so desired.

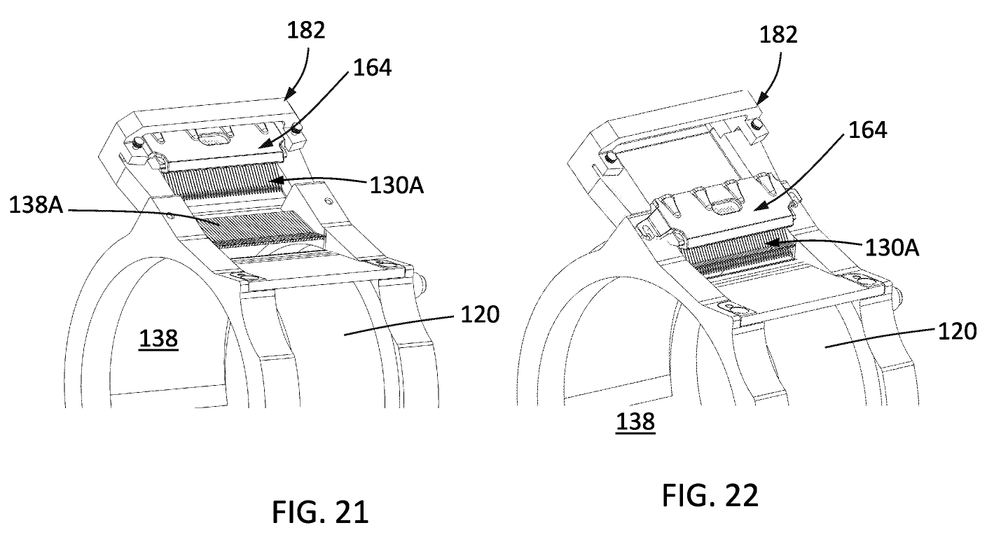

FIGS. 21 and 22 depict steps entailed in installing the mounting fixture 164 on a size-reduction machine using the assembly fixture 182. In FIG. 21, the assembly fixture 182 is aligned with the slots 160 of the gate insert 138A (or gate 138) assembled on the case 120, and FIG. 22 shows the result of releasing the flanges 190 of the carrier 166 from the assembly fixture 182 and translating the mounting fixture 164 to engage the knives 130A with the slots 160, as discussed previously. From the foregoing discussion of FIGS. 16 through 22, it can be appreciated that the assembly and installation of the mounting fixture to the machine can be performed with little risk of injury from the knives 130A.

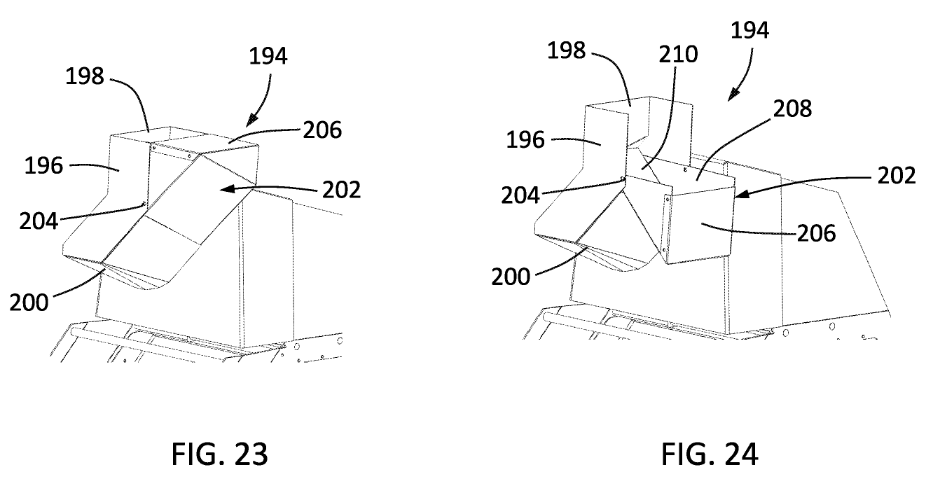

FIGS. 23 and 24 represent another additional feature capable of being incorporated into a size-reduction machine, as a nonlimiting example, the DiversaCut Sprint® machine represented in FIG. 1. FIGS. 23 and 24 depict a feed assembly 194 capable of delivering products to the size-reduction machine. The feed assembly 194 comprises a chute 196 having a chute opening 198 adapted for receiving product from a conveyor (not shown) or other suitable delivery apparatus located above the opening 198, and delivering the product to a chute discharge 200 at a lower end of the chute 196, by which the chute 196 may be directly connected to the entrance to the case (20 in FIG. 1, 120 in FIGS. 4-12) of the machine. A bin 202 is pivotally attached at 204 to the chute 196. The bin 202 has a closure 206 adjacent the chute opening 198 so that product delivered to the chute 196 does not inadvertently enter the bin 202. In FIG. 24, the bin 200 has been rotated away from the chute opening 198, exposing a cavity 208 within the bin 202 that can accommodate a limited quantity of product. While rotated to expose the cavity 208, an interior wall 210 of the bin 202 prevents access to the interior of the chute 196 and the case therebelow. By rotating the bin 202 to return it to its position shown in FIG. 22, the contents of the cavity 208 are deposited into the chute 196 for delivery to the case.

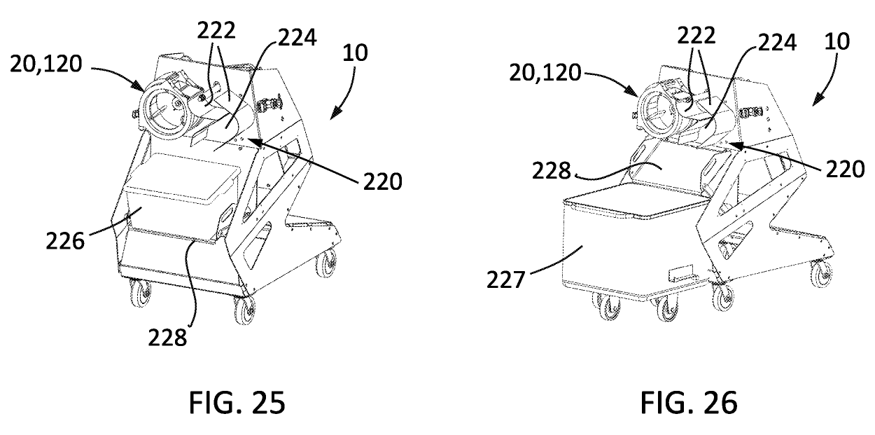

FIGS. 25 and 26 represent yet another feature capable of being incorporated into a size-reduction machine, as a nonlimiting example, the DiversaCut Sprin® machine represented in FIG. 1. FIGS. 25 and 26 depict a product discharge 220 capable of discharging processed product from the machine 10 after being reduced in size, for example, using the case 20 in FIG. 1 or the case 120 of FIGS. 4-12. The discharge 220 comprises a pair of deflectors 222 that are located at the exit of the case 20/120 and downstream of moving machinery (e.g., a cross-cutter such as shown in FIG. 1) of the machine 10. The deflectors 222 define a chute 224 therebetween. The deflector 222 nearest the case 20/120 has a V-shaped cross-section and is nested within the second deflector 222 have a U-shaped cross-section. The V-shaped deflector 222 transitions the processed product exiting the case 20/120 from a generally vertical (downward) trajectory to a generally horizontal trajectory, and the curvature of the U-shaped deflector 222 transitions the processed product from a generally horizontal trajectory to a generally vertical (downward) trajectory for reception by a receptacle disposed beneath the discharge 220. The deflectors 222 cause the chute 224 therebetween to define a curved path that promotes safety by preventing an individual from being able to access the moving machinery downstream of the case 20/120 (e.g., a cross-cutter such as shown in FIG. 1) from above while the machine 10 is operating. In FIG. 25, the deflectors 222 conduct the product directly into a bin 226 supported on a tray 228. In FIG. 26, the tray 228 has been pivoted upward to serve as a second deflector for conducting the product from the chute 224 into a bin 227 depicted as self-supporting.

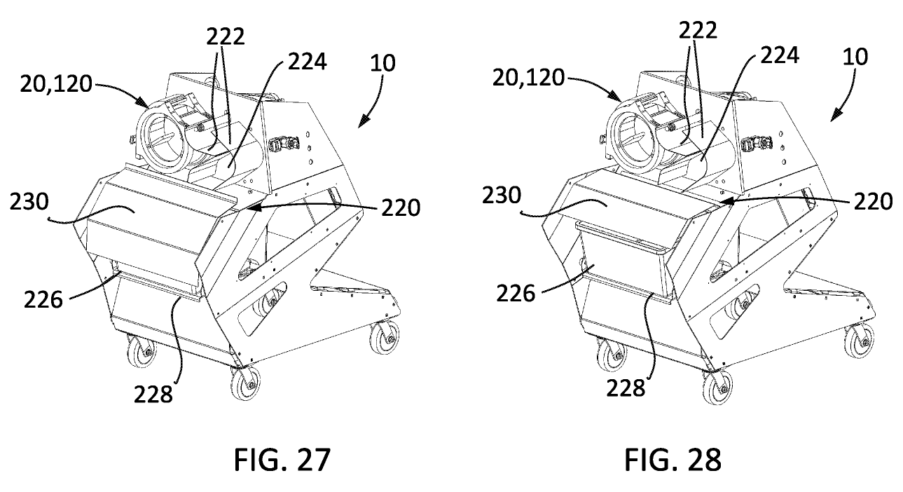

In FIGS. 27 and 28, the product discharge 220 is represented as further equipped with a discharge door 230 adapted to translate for the purpose of covering the bin 226 and simultaneously exposing the exit of the chute 224 to allow products to enter the bin 226, as shown in FIG. 27. In FIG. 28, the door 230 is shown as having been translated upward to block the exit of the chute 224 and provide access to the bin 226, enabling the bin 226 to be removed from the machine 10.

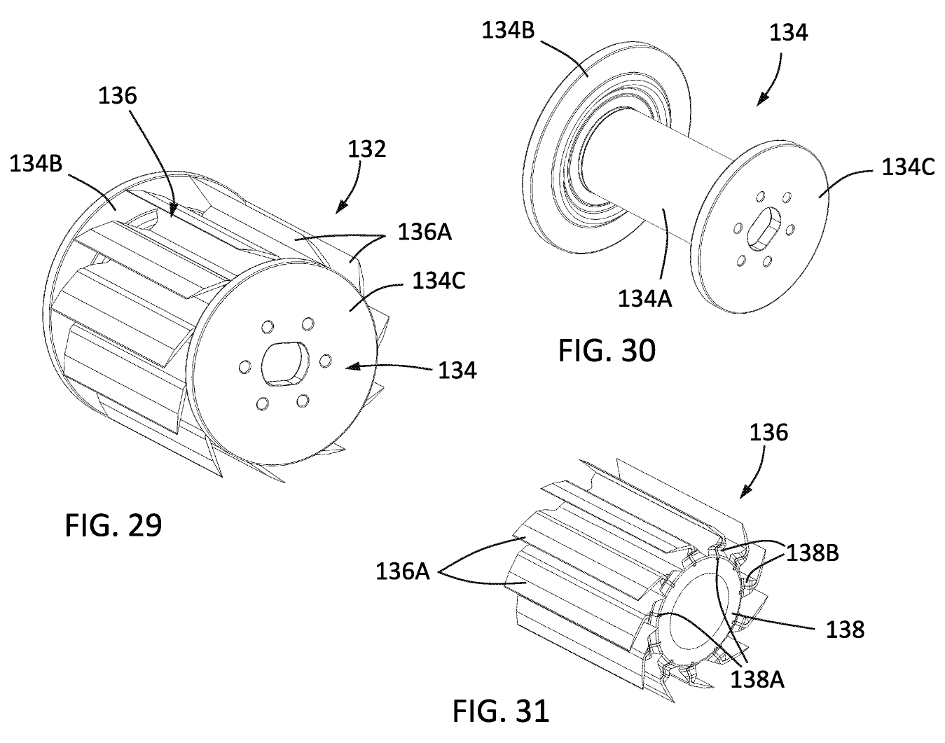

FIGS. 29 through 32 represent yet another feature capable of being incorporated into a size-reduction machine, as a nonlimiting example, the DiversaCut Sprint® machine represented in FIG. 1. FIGS. 29 through 32 relate to an alternative to the cross-cutter 32 of FIG. 1 that is used to cut the strips into the diced product 36. FIG. 29 represents a cross-cutter 132 comprising a spindle 134 and a knife assembly 136 mounted to the spindle 134. The knife assembly 136 is represented in FIG. 31 as comprising an insert 138 having a plurality of peripheral slots 138A into which cross-cut knives 136A are installed along the circumference of the insert 138. FIG. 30 represents the spindle 134 as comprising a central hub 134A and end caps 134B and 134C attached to the hub 134A, though optionally one of the end caps 134B and 134C may be formed integrally with the hub 134A. The insert 138 serves as a spacer for the knives 136A, which are installed in the peripheral slots 138A, which are represented in FIG. 31 as formed in radial projections 138B that extend longitudinally along the length of the insert 138. The insert 138 may be formed of a plastic material to reduce costs and the spindle 134 if the latter is constructed of a material that is stronger than the insert 138, for example, a food grade steel, bronze, etc., to provide the structure, rigidity, precision, location, and clamping functions required by the cross-cutter 132. If formed of a plastic material, the insert 138, including its projections 138B and other geometry features, is amenable to fabrication by injection molding, 3D-printing, etc. However, it is also within the scope of the invention to construct the insert 138 from other materials, as a nonlimiting example, a stainless steel. In either case, a benefit is the ability to separately replace the insert 138 and/or hub 134A in the event that either is damaged.

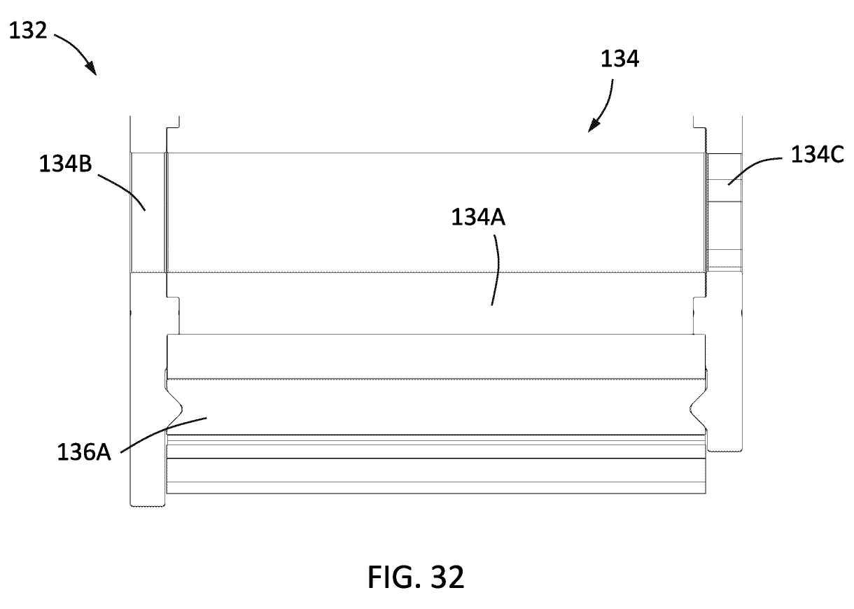

FIG. 32 is a cross-sectional view of the cross-cutter 132 through its axis of rotation, coinciding with the axis of the hub 134A. FIG. 32 represents the manner in which the insert 138 is engaged by the end caps 134B and 134C of the spindle 134 to secure the knives 136A within the slots 138A of the insert 138.

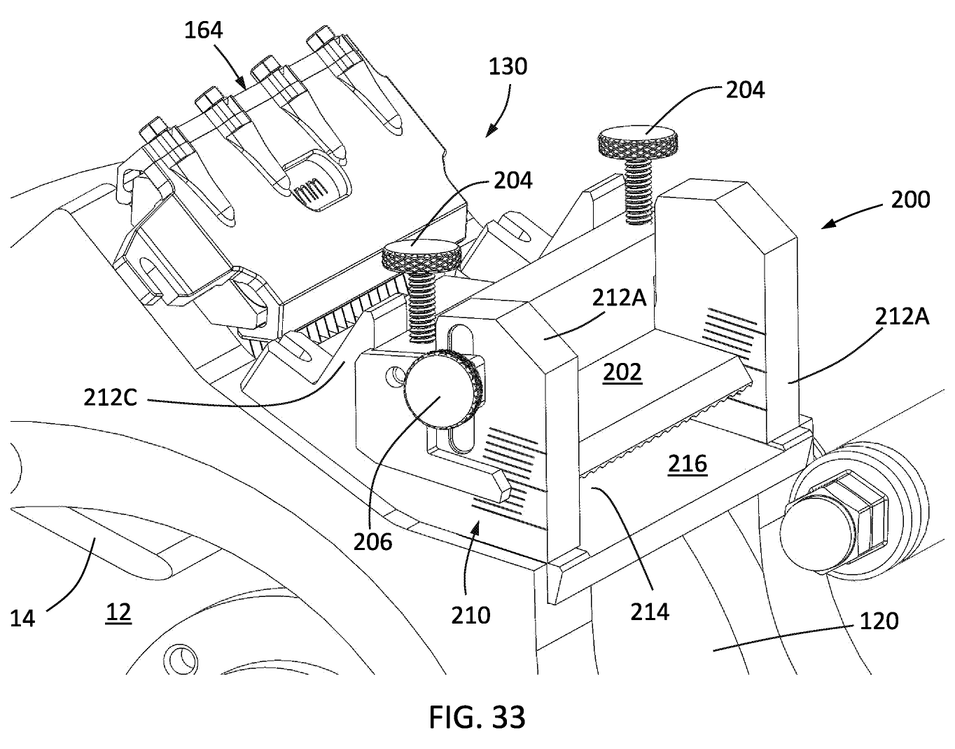

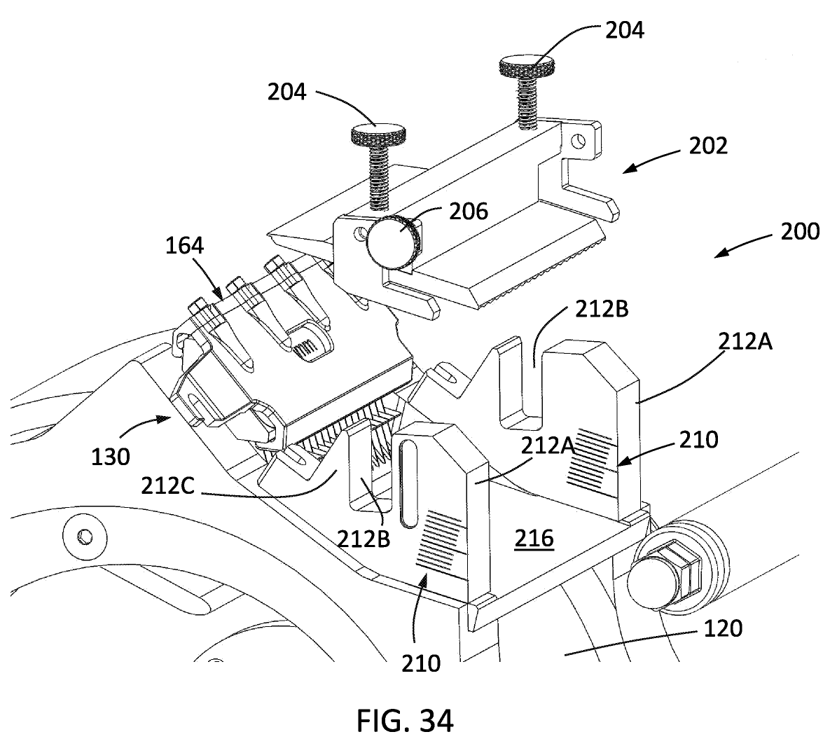

FIGS. 33 through 35 represent a slice guide adjustment mechanism 200 capable of use with any machine 10 as described above. As represented, the adjustment mechanism 200 is an independent slice guide adjustment that is not dependent on the linearly translating gate 138 represented in FIGS. 4 through 10. The adjustment mechanism 200 has a product guide 202 adjustably mounted between a pair of frame guides 212A. The product guide 202 is received within cradles 212B (FIG. 34) formed by the frame guides 212A and bears against a sliding guide 212C of the cradles 212B. The height of the guide 202 between the frame guides 212A can be adjusted with a pair of adjustment knobs 204 to define a guide path 214 whose height above an outer surface 216 of the case 120 is equal to or greater than the thicknesses of the slices being produced. The frame guides 212A include graduated markings 210 by which the guide path 214 can be precisely adjusted to be equal to the thicknesses of slices being produced, which enables a downstream dicing operation (e.g., such as with the cross-cutter 132 of FIGS. 29 through 31) to be more precisely performed.

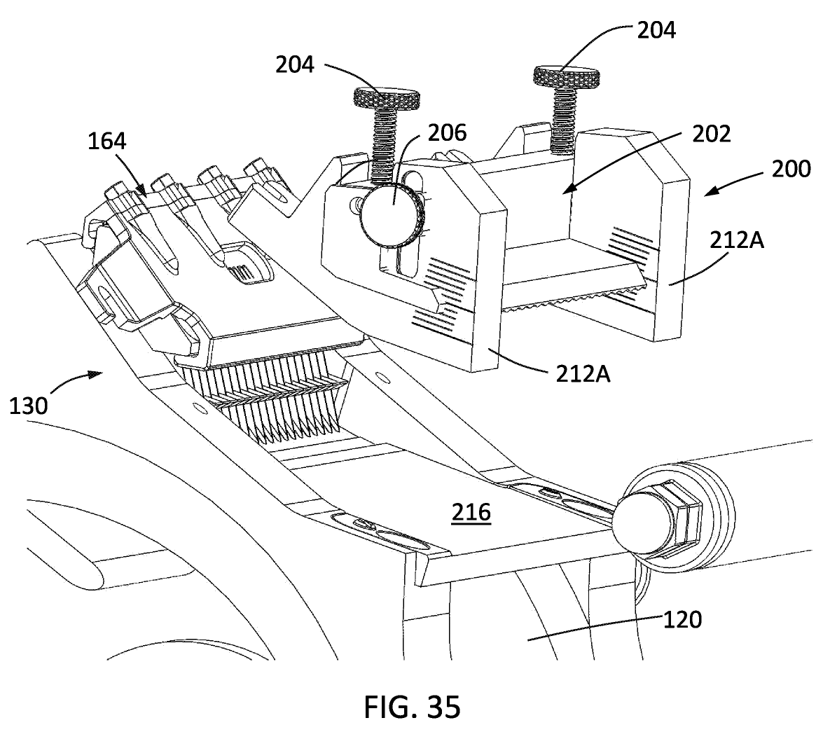

The adjustment mechanism 200 is shown as configured with locking knobs 206 that, as represented in FIG. 34, enable the product guide 202 to be quickly secured to and removed from the frame guides 212A without affecting the height of the guide path 214. Alternatively, the entire adjustment mechanism 200 can be removed from the case 120 as represented in FIG. 35.

While the invention has been described in terms of a specific or particular embodiment, it is apparent that alternatives could be adopted by one skilled in the art. For example, the size-reduction machine and its components could differ in appearance and construction from the embodiments described herein and shown in the drawings, functions of certain components of the machine could be performed by components of different construction but capable of a similar (though not necessarily equivalent) function, and various materials could be used in the fabrication of the machine and its components. Accordingly, it should be understood that the invention is not necessarily limited to any embodiment described herein or illustrated in the drawings.

1. A size-reduction machine having a case, an impeller that rotates within the case, and a cross-cutter that comprises:
a spindle comprising a hub and first and second end caps, at least the first end cap being attached to the hub,; and
a knife assembly mounted to the spindle, the knife assembly comprising an insert formed of a material and having a length, a circumference, radial projections that extend longitudinally along the length of the insert, peripheral slots formed in the radial projections, and cross-cut knives installed in the peripheral slots so as to be spaced apart along the circumference of the insert, the insert serving as a spacer for the cross-cut knives;
wherein the insert and the spindle are constructed of different first and second materials, respectively, and the second material of the spindle is stronger than the first material of the insert.

2. The size-reduction machine of claim 1, wherein the second material of the spindle is a food grade steel or bronze.

3. The size-reduction machine of claim 1, wherein the first material of the insert is a plastic material.

4. The size-reduction machine of claim 3, wherein the insert and the peripheral projections thereof are injection molded components or 3D-printed components.

5. The size-reduction machine of claim 1, wherein the first material of the insert is a stainless steel.

6. The size-reduction machine of claim 1, wherein the first and second end caps of the spindle engage the insert to secure the cross-cut knives within the peripheral slots of the insert.

7. The size-reduction machine of claim 1, wherein the impeller is surrounded by the case and has a common axis with the case, the case comprises a slicing knife mounted on a perimeter of the case.

8. The size-reduction machine of claim 7, wherein the cross-cutter is part of a dicing unit located downstream of the slicing knife.

9. The size-reduction machine of claim 7, wherein the case comprises a moveable gate leading the slicing knife such that products carried by the impeller within the case slide across an inner wall of the moveable gate before encountering the slicing knife.

10. The size-reduction machine of claim 9, wherein the case comprises an adjustment device that translates the moveable gate and restricts the moveable gate to linear translation along a linear path.

11. The size-reduction machine of claim 9, further comprising a cutting device leading the slicing knife, the cutting device comprising a mounting fixture and stationary strip knives that are spaced apart and parallel to each other by the mounting fixture.

12. The size-reduction machine of claim 11, wherein the strip knives pass through slots located at a trailing edge of the moveable gate to immobilize the strip knives in an axial direction of the case.

13. The size-reduction machine of claim 11, wherein the strip knives extend to the slicing knife such that tips of the strip knives contact a surface of the slicing knife at locations in a trailing direction behind a cutting edge of the slicing knife.

14. The size-reduction machine of claim 11, wherein the strip knives have a dovetail feature received and retained by the mounting fixture.

15. The size-reduction machine of claim 11, wherein each of the strip knives has a cutting edge disposed at an angle of inclination relative to a radial of the case so that the cutting edges cause the products to gradually undergo strip cutting.

16. The size-reduction machine of claim 11, further comprising an assembly fixture in which the strip knives are assembled with the mounting fixture.

17. The size-reduction machine of claim 7, further comprising a feed assembly comprising:
a chute having a chute opening adapted for receiving a product from the slicing knife; and
a bin pivotally attached to the chute so that rotating the bin away from the chute opening exposes a cavity within the bin that accommodates a limited quantity of the product, an interior wall of the bin prevents access to the chute, and the product within the cavity is deposited in the chute by rotating the bin toward the chute opening.

18. The size-reduction machine of claim 7, further comprising:
a product discharge for discharging processed product from the size-reduction machine after being reduced in size by the slicing knife, the product discharge comprising deflectors located at an exit of the case and defining a chute therebetween;
a bin for receiving the processed product; and
a tray adapted to support the bin and adapted to be pivoted upward to serve as another deflector for conducting the processed product from the chute.

19. The size-reduction machine of claim 18, further comprising a discharge door adapted to translate to cover the bin and simultaneously expose an exit of the chute to allow the processed product to enter the bin, and adapted to translate to block the exit of the chute, provide access to the bin, and enable the bin to be removed from the size-reduction machine.

20. The size-reduction machine of claim 7, further comprising a slice guide adjustment mechanism downstream of the slicing knife, the slice guide adjustment mechanism defining a guide path that can be adjusted to be equal to thicknesses of slices being produced by the slicing knife.
